(19) United States
(12) Patent Application Publication
(10) Pub. No.: US 2010/0187793 A1
(43) Pub. Date: Jul. 29, 2010

(54) Trailer Bump

(76) Inventor: Ricky Neal O'Quinn, Brunswick, GA (US)

Correspondence Address: Ricky Neal O'Quinn, 220 Waters Rd., Brunswick, GA, 31523, US

(21) Appl. No.: 12/322,301

(22) Filed: Jan. 27, 2009

(51) Int. Cl. B60D 1/36

(52) U.S. Cl. 280/477

(57) ABSTRACT

A trailer hitch alignment device facilitates the alignment of the trailer tongue with the drop hitch ball of the towing vehicle. The device includes a vertical back plate, curved in the middle to create an obtuse angle to partially surround a drop hitch ball in order to guide the tongue of a trailer toward the ball hitch. The invention is held in proper orientation by a snug, tight fit between the hitch post and base plate with the hitch ball working as a locking devise. The 1′×¼″ bar at the top of the device is used as added security to keep the trailer attached to the towing vehicle.

### STATEMENT REGARDING FEDERALLY SPONSORED RESEARCH OR DEVELOPMENT

This invention is not sponsored by the Federal government. No research and or development have been sponsored by the Federal Government pertaining to this invention.

### CROSS REFERENCE TO RELATED APPLICATIONS

There is no known prior or co-pending non-provisional applications filed pertaining to this invention.

### DRAWINGS

A complete set of scale drawings are attached to this application. See below for an accurate description of the drawings.

### BACKGROUND OF THE INVENTION

This invention will be installed on a standard receiver automotive trailer hitch. The unit is designed to do several things such as:
1. Help align the trailer with the center of the receiving vehicle. This done by backing the receiving vehicle slowly towards the trailer until the tongue of the trailer bumps the “Trailer Bump” Once this happens the trailer tongue can be lowered onto the receiving vehicles hitch.
2. The Trailer Bump is also designed to secure the trailer tongue on to the receiving vehicles hitch. This is done by inserting the cross bar of the Trailer Bump through the two upper holes and securing with the supplied ring clip. Once the cross bar is installed the trailer tongue cannot rise up and off of the hitch ball, thus protecting the rear of the receiving vehicle and securing the trailer to the receiver hitch and reducing the possibility of the trailer coming un-hooked from the towing vehicle.
3. The Trailer Bump is also designed to protect the receiving vehicle from damage due to over turning the trailer or other wise known as a “Jack knife”. Once the trailer reaches its maximum turning radius, it will bump the Trailer Bump and the trailer will start to slide but the tongue of the trailer will not hit the receiving vehicle.

There are no known specific documents pertaining to this invention.

### SUMMARY OF THE INVENTION

This invention is designed to align the tongue of a trailer while it is being installed onto a towing vehicle. It is also designed to protect the towing vehicle from damage due to a Jack knife or over turning of the trailer by the tow vehicle. The Trailer Bump is also designed to help secure the trailer to the towing vehicle by allowing for very little movement up or down of the tongue of the trailer. The unit is constructed of steel and is designed to fit a standard trailer receiving hitch. The Trailer Bump is designed to be installed by sitting the unit on the standard receiving hitch without the hitch ball installed but where the ball is normally installed. Once the unit is placed on the receiving hitch where the ball is normally installed, insert the shaft of the hitch ball through the hole on the Trailer Bump and install the lock washer and nut of the hitch ball in the normal fashion making sure the nut is tight on the shaft of the ball. At this point the Trailer Bump is installed and ready for use. The Trailer can be used with any sized hitch ball and can be used on any standard aftermarket towing package.

### DESCRIPTION OF THE DRAWINGS

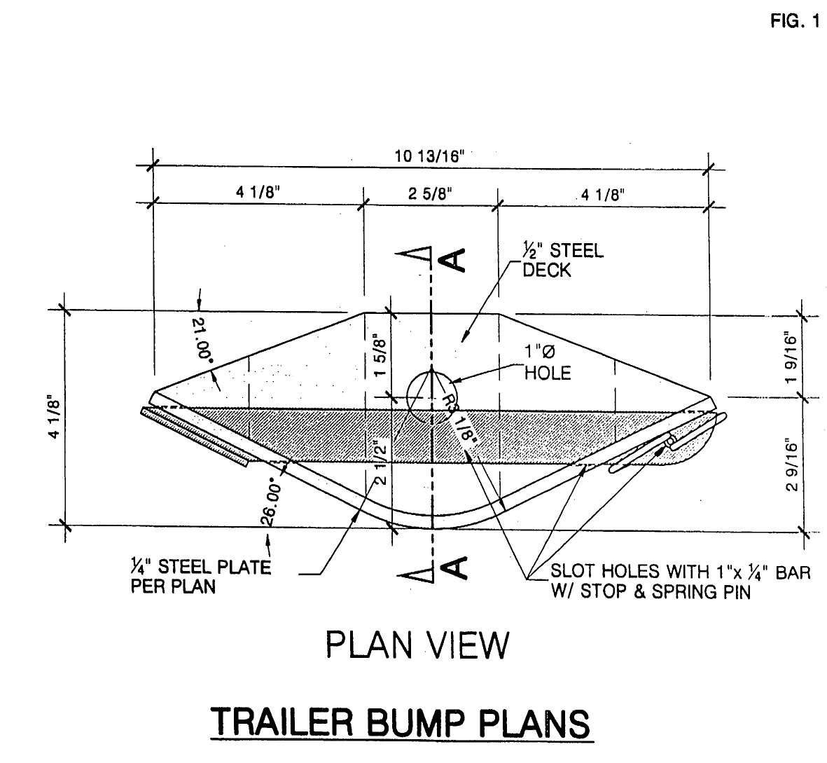

FIG. 1—Is the Plan view of the top of the Trailer Bump in an embodiment of the present invention.

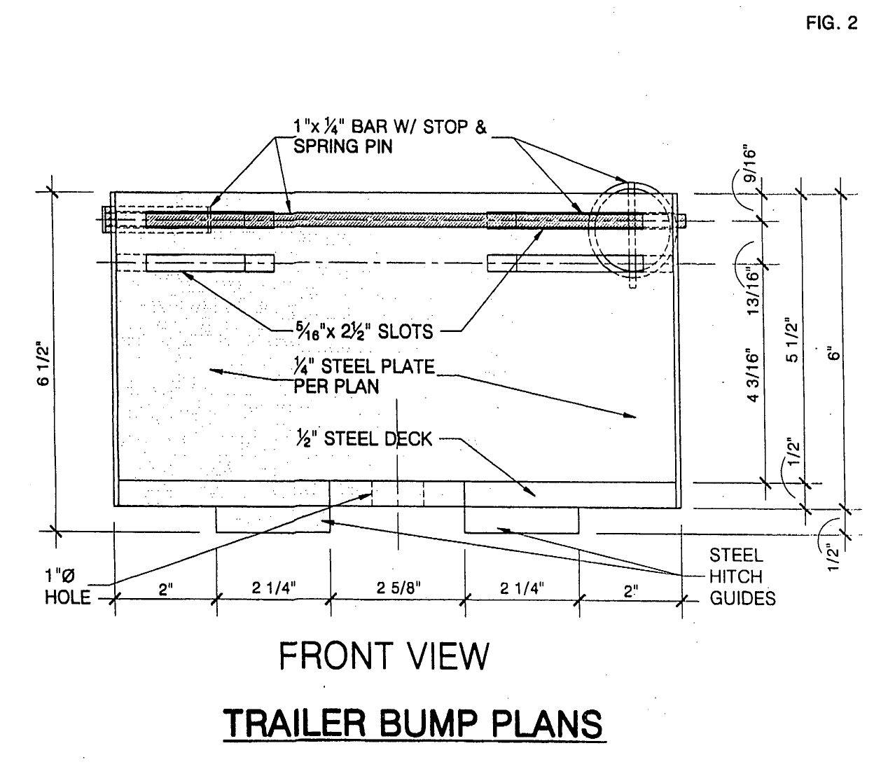

FIG. 2—Is the front view of the Trailer Bump in an embodiment of the present invention.

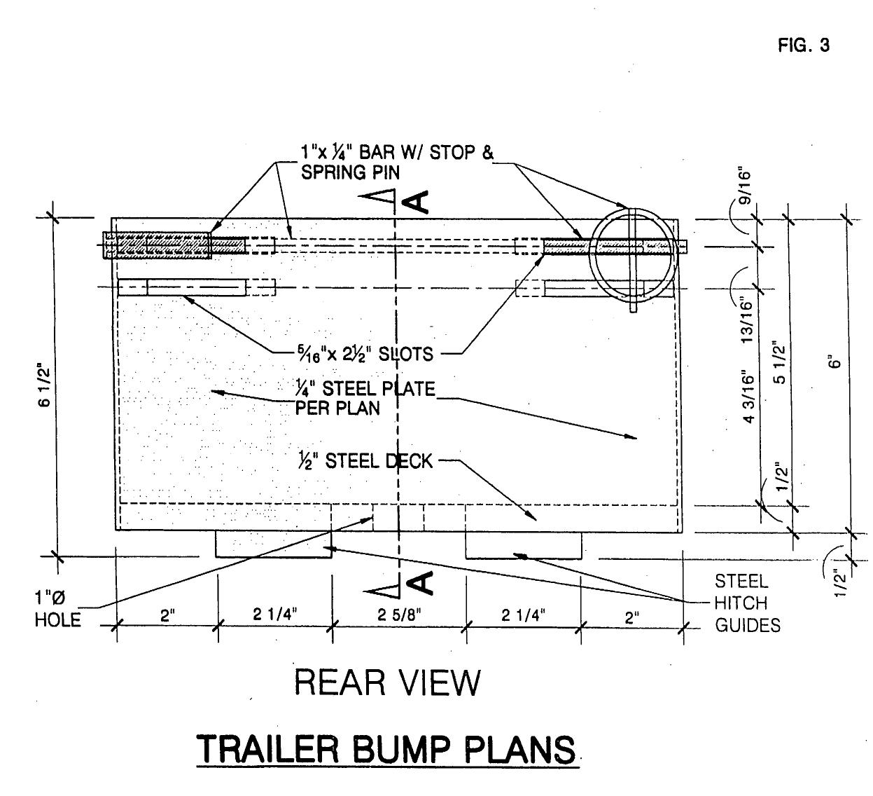

FIG. 3—Is a rear view of the Trailer Bump in an embodiment of the present invention

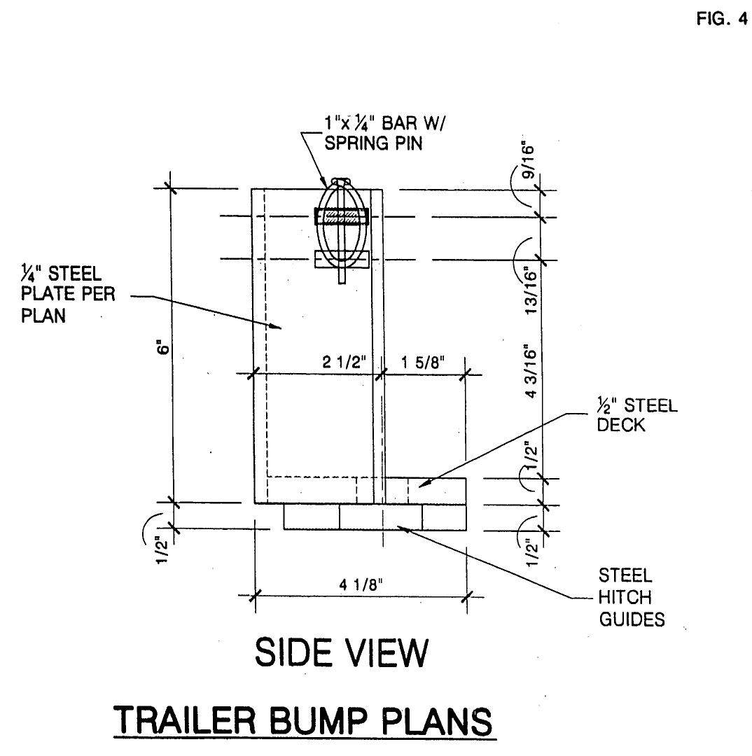

FIG. 4—Is a side view (Right Side) of the Trailer Bump in an embodiment of the present invention.

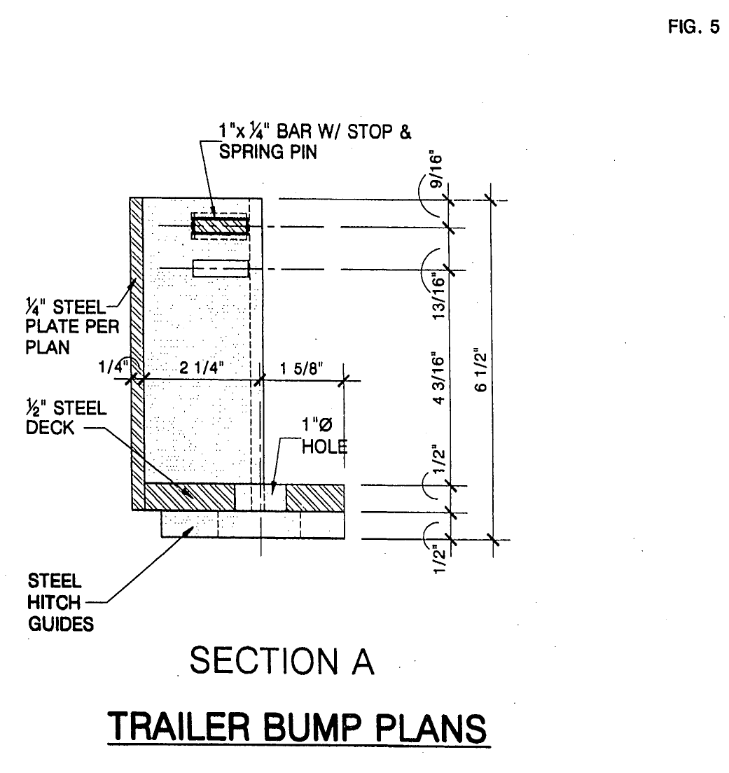

FIG. 5—Is a side view (Right Side View) of the Trailer Bump in an embodiment of the present invention.

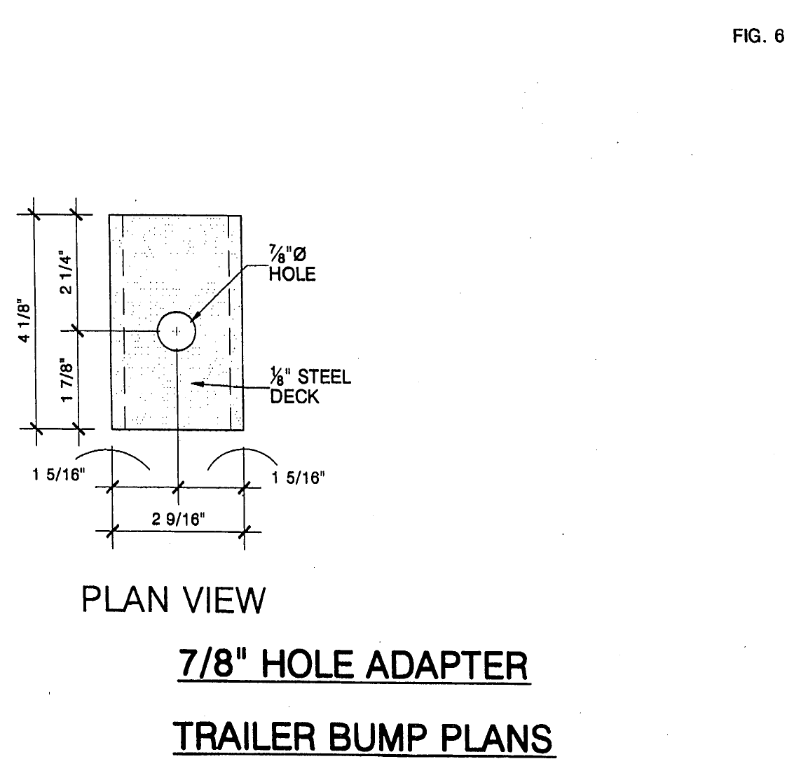

FIG. 6—Is a plan view of the ⅞″ hole adapter as seen when looking down on the invention

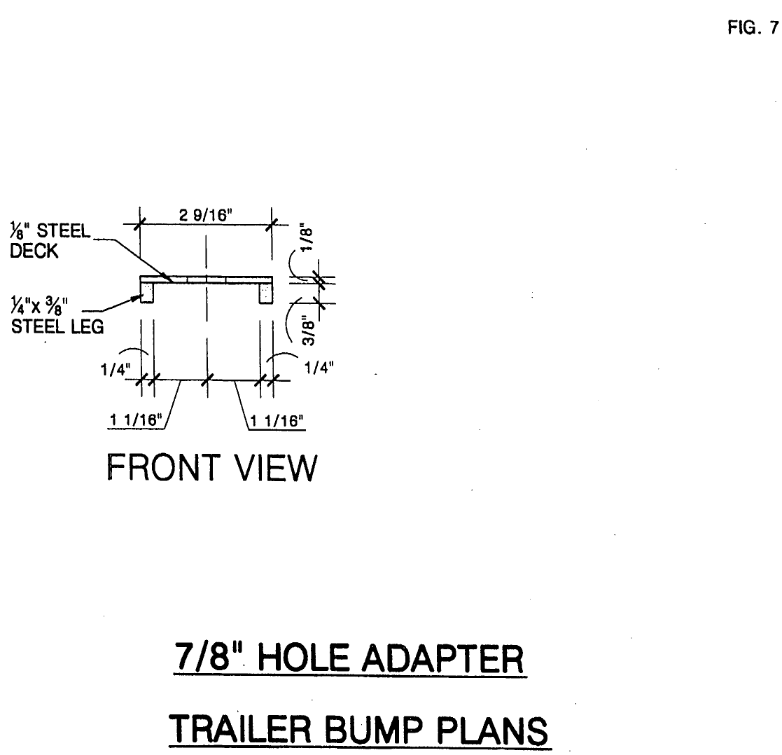

FIG. 7—Is a front view of the ⅞″ hole adapter as seen when looking straight at the invention

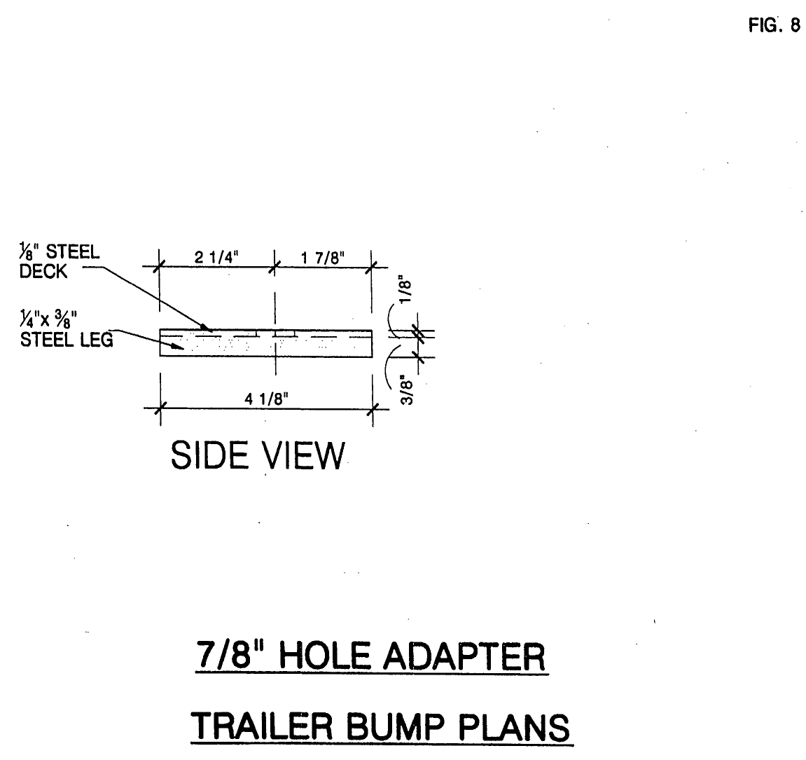

FIG. 8—Is a side view of the ⅞″ hole adapter as seen when looking from the right or left side. Both sides are identical.

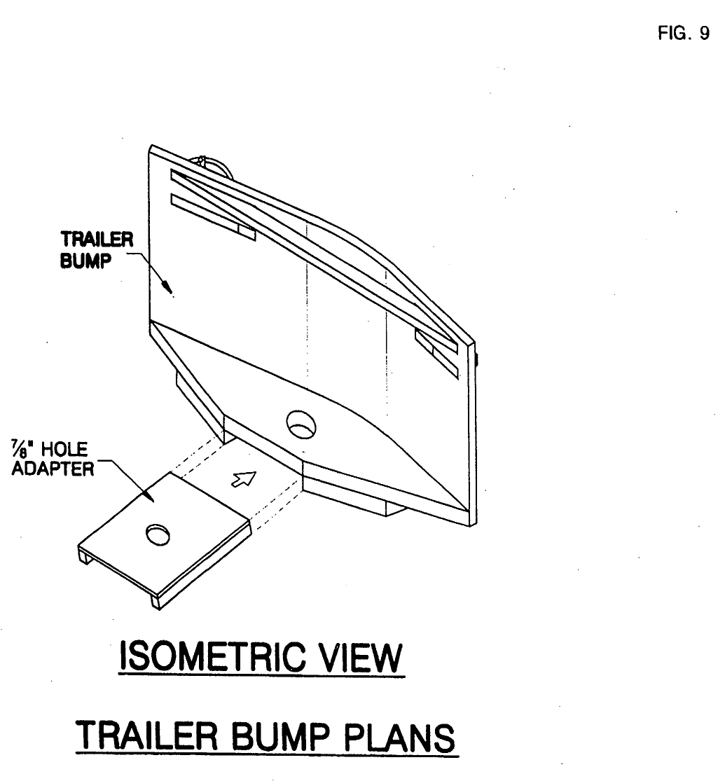

FIG. 9—Is an isometric view of the present invention. This view also shows how the hole adapter works and can be used in conjunction with the present invention.

### DESCRIPTION OF THE INVENTION

1. The Trailer Bump is designed to work in conjunction with most automotive receiver hitches. It provides the receiving vehicle a point of reference or a guide to keep the trailer aligned with the receiving vehicle. It also aids in safety by better securing the trailer to the receiving vehicle and helps prevent damage to the receiving vehicle by keeping the tongue of the trailer away from the bumper or body of the receiving vehicle.

2. The entire Trailer bump is constructed of steel per the attached drawings. The front of the Trailer Bump also has 2-2″ slots in the upper right and left corner to allow for the cross bar to be installed. The cross bar is what aids in the safety of the trailer not coming loose from the receiving vehicle. The cross bar is constructed of 1′×¼″ steel and is 12″ in length. The base of the Trailer Bump is also constructed of steel and has two 1″ holes allowing a hitch ball and shaft to be inserted through it. The reason for two holes is to allow for adjustment in the event it is needed to accommodate different types of receiver hitches. The base also has two additional pieces of ¼″ steel installed on the bottom of the unit to allow for the unit to sit on the standard receiving hitch. The additional pieces of steel are 2.5″×6″ and are evenly spaced 2″ from the center of the hitch holes on the base of the unit.

3. The unit weighs approximately 22 lbs. and is simple to install.

4. When used properly the Trailer Bump will provide a guide for the receiving vehicle that will allow the tongue of the trailer to be centered with the receiving vehicle. It will provide a safety feature that will aid in the trailer to remain secure with the receiving vehicle and it will help prevent damage to the receiving vehicle by protecting the vehicle from the trailer tongue during a Jack Knife or over turning of the trailer. The Trailer will also provide an added layer of protection to the receiving vehicle in a rear end collision.

1. The Trailer Bump is a steel unit designed to be installed on a standard automotive receiver hitch. The unit is placed on the receiver hitch with the hitch ball off, on top of where the hitch ball is normally placed. The hitch ball is then re-installed and the unit is ready to use. The Trailer Bump is designed to aid in aligning the receiving vehicle with the tongue of the trailer. It is also designed to protect the receiving vehicle from damage caused by over turning the trailer or otherwise known as a Jack Knife, and the Trailer Bump is designed to hold the tongue of the trailer to the ball hitch. The Trailer Bump has a cross bar on the top of it which will stop the tongue of the trailer if it were to come loose from the hitch ball or if the hitch ball came loose from the receiver hitch. The unit is constructed of steel and has two holes that allow for proper fit to most standard receiver trailer hitches. The unit can be installed on any vehicle equipped with a standard receiver hitch.
